(19) United States
(12) Patent Application Publication
(10) Pub. No.: US 2026/0111954 A1
(43) Pub. Date: Apr. 23, 2026

(54) Free, paid media entertainment credit system and media market place, to access paid media entertainment, paid games, paid AR/VR services/games, paid streaming services, temporarily for free across different platforms using the new credit and trade, publish media

(71) Applicant: Navtej Singh Dhillon, Supply, NC (US)

(72) Inventor: Navtej Singh Dhillon, Supply, NC (US)

(21) Appl. No.: 18/918,853

(22) Filed: Oct. 17, 2024

(51) Int. Cl. G06Q 40/03; G06Q 20/06

(52) U.S. Cl. CPC G06Q 40/03; G06Q 20/065

(57) ABSTRACT

Intend to invent and create, free paid media entertainment media credit system and media market place, which will enable an end user to access media entertainment, games, AR/VR, streaming services, on any platform, temporarily for free using the new credit system which otherwise needs to be paid. The system will build free paid media credit based on a users different usage of products, services, promotions on other products and services that give free media credit. Buying products that will give this credit and will apply on the platform of users liking to show the paid content without paying rather using the credit. This system will embedded many media systems underneath making it a universal cross media platform market place also, powered by digital token, enabling media trade and publishing across platforms.

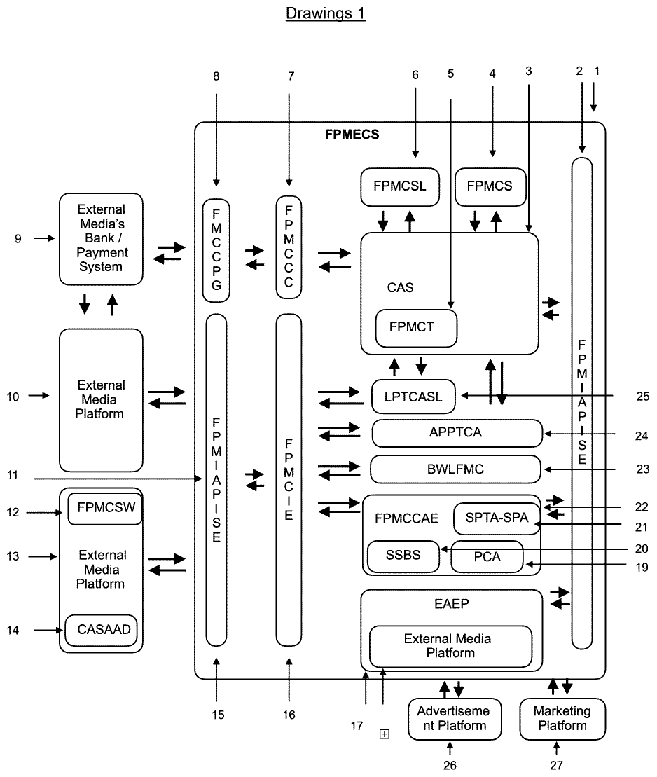

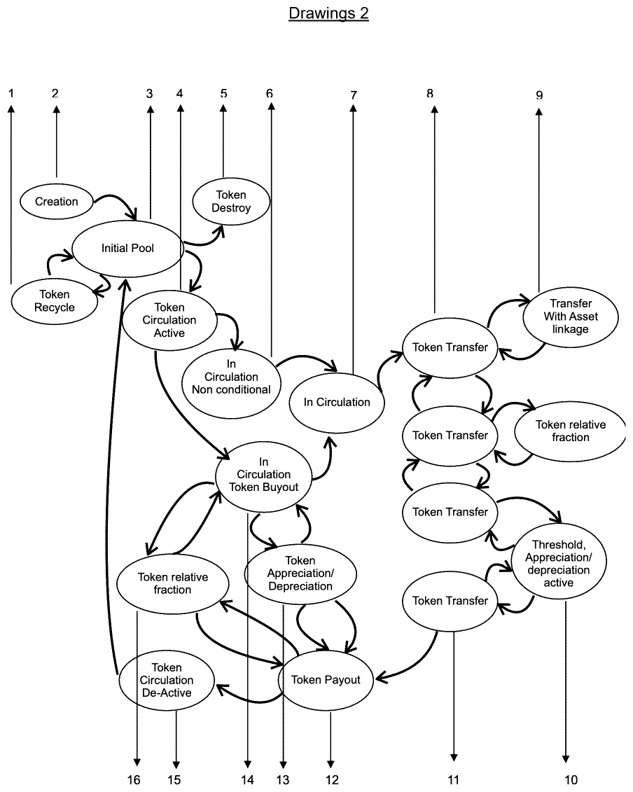

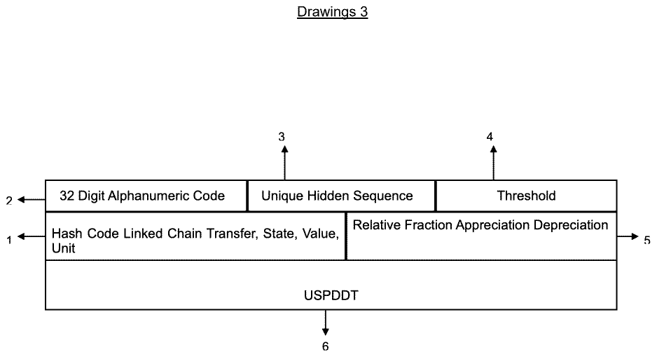

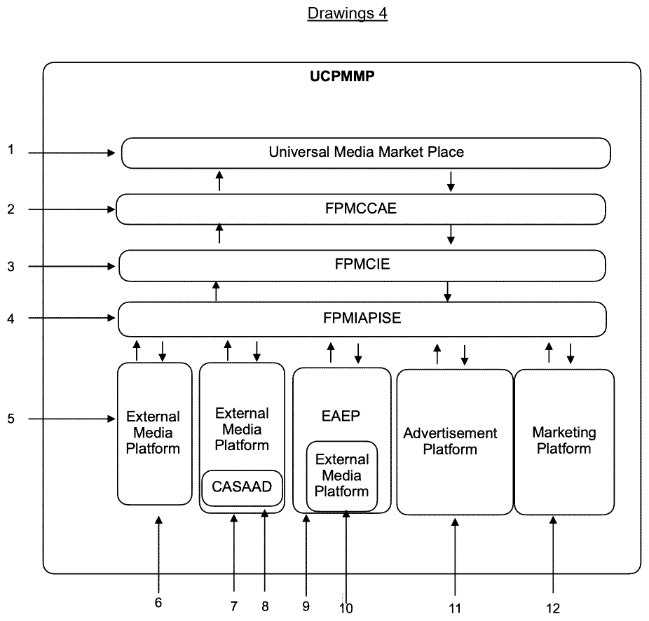

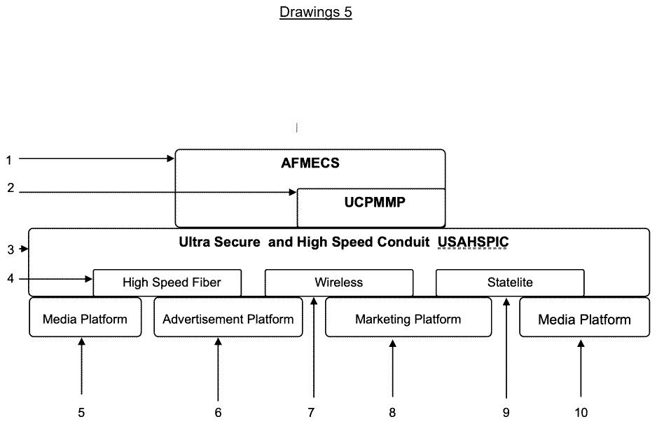

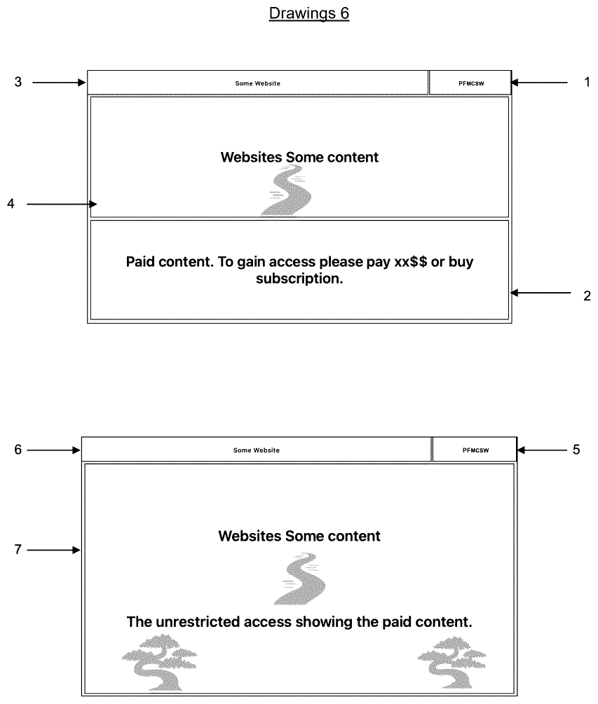

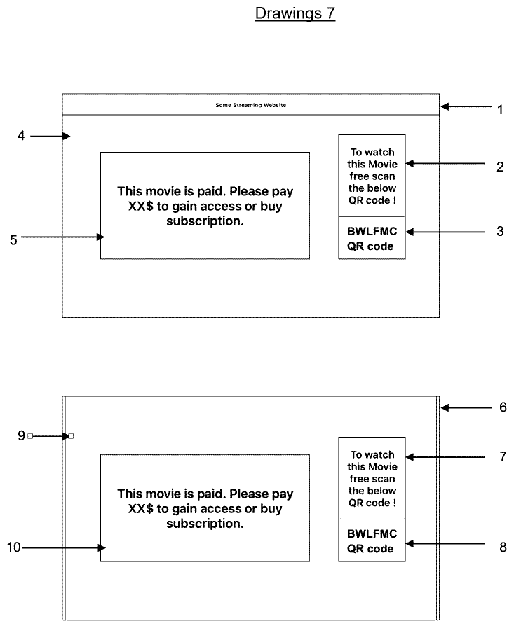

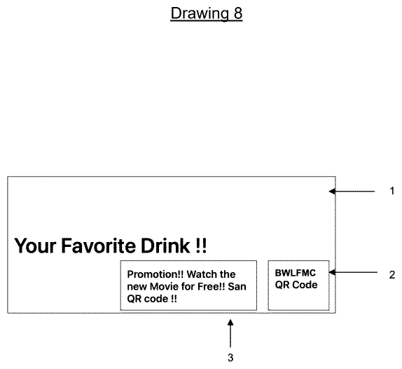

### CROSS-REFERENCE TO RELATED APPLICATIONS

This application takes advantage of the provisional filled application. Application No: 63/666,659

Further the provision application is broken down into two different patents, where this non-provisional patent application covers the “free paid media entertainment credit system and media marketplace” and “advertisement free media entertainment credit system and media market place” is filled in another non-provisional patent application.

### BACKGROUND OF THE INVENTION

B.1 Currently some of the premier media services like premier TV stations, premier streaming services, premier websites, mobiles apps, tablets apps, AR/VR services, games, are only accessible as paid content, for most of which an end user have to buy the subscription or rent or pay one time fee or pay for the content.

B.2 Currently for different platforms like YouTube, TV stations, streaming services, websites, mobiles apps, tablets apps, AR/VR services, games, etc, different advertisements are shown and the end user have to watch or listen to those advertisements as part of the content. To not to watch the advertisements some platforms offer paid subscriptions.

B.3 There does not exists a means by which an end user can access paid media content temporarily, without buying the subscription or renting or one time pay. A means exists not where an end user can watch the otherwise paid content, temporarily, using some sort of credit which is either acquired or bought or given in promotion.

B.4 As of today different promotions are being offered by manufacturers, stores, shops, media entertainment, etc, which gives an end user some sort of credit, but there exists not a means where a credit system which can temporarily give an end user free paid premiere content.

B.5 There exists not a cross platform system which can give an end user credit based on what the end user is watching, using the services or the products and services that are bought, and the same credit can be applied towards accessing the content for free which otherwise needs to be paid.

B.6 There exists not a way which can work across different media platforms, giving the end user the ability to purchase or earn some form of credit once, but be able to apply it across different platforms, end user to access the media content it desires. There exists not a cross platform seamless experience across different media platforms and types.

B.7 There exists not a way where different media content can be traded freely across different platforms and regions, online. There still lacks ways in which the collaboration, and creativity across the regions can be taken to next level.

B.8 No new ways have been found in which advertisements can be shown without interrupting the experience of the entertainment.

B.10 Though the promotions intent to promote the products but current promotions tend to still lack in having a positive influence, there exists not a way where the money spent on promotions can be more direct and more influential.

B.11 There exists not a fully online media market fully online with collaboration place across different platforms, geographies, where the content can be not only traded freely, royalty be earned directly and nor exist the ability to publish across different platforms without much hassle.

### BRIEF SUMMARY OF THE INVENTION

S.0 Intend to invent and create, free paid media entertainment media credit system and media market place, which will enable an end user to access media entertainment, games, websites, mobiles, tablets, AR/VR, streaming services, on any platform, temporarily for free using the new credit system which otherwise needs to be paid and trade, publish media. Free paid media entertainment media credit system and media market place, which will enable an end user to access media entertainment, games, Web browsers, websites, mobiles, tablets, AR/VR, streaming services, on any platform, temporarily for free using the new credit system which otherwise needs to be paid or advertisements needs to be watched. The system will build free paid media credit based on a users different usage of products, services, promotions on other products and services that give advertisement free media credit. Buying products that will give this credit and will apply on the platform of users liking to show paid content without paying rather than using the credit, with new ways accessing the media. This system will embedded many media systems underneath making it a universal fully online cross media platform market place powered by digital token, also giving the end user seamless access to the media of liking by using the new credit system, trading, collaborating and publishing the media content.

S.1 Intend to invent and create, free paid media entertainment credit system, which will enable an end user to access media entertainment, games, websites, mobiles, tablets, AR/VR, streaming services, on any platform, temporarily for free using the credit which otherwise needs to be paid.

S.2 The system will build free paid media credit based on a users different usage, promotions that give free media credit, buying products that will give this credit and will apply on the platform of users liking to show the paid content without paying rather than using the credit. The system will comprise of various computer systems, engines, streaming engines, encapsulating engines, GUIs, interfaces and api's that will intact with existing or new media entertainment platforms, marketing and advertisement systems.

S.3 Intend to invent and create cross platform system, which will help end users earn credit, based on the users use of different services, media entertainment services, purchase of products and services, where this credit can be applied on media platforms like YouTube, apple iTunes, games, Web browsers, websites, mobiles, tablets, AR/VR, streaming services, or on any platform etc, to access content temporarily for free which otherwise needs to be paid.

S.4 The system will accumulate the credit for an end user from different platforms, services the end user use, promotions that give the end user the credit, and for the users liking the system will grant access to paid content by passing the credit to platform where the end user wants to access the paid content.

S.5 The system will give temporary access to the end user to the premiere services using the earned credit which otherwise needs to be paid.

S.6 Different manufacturers, stores, shops, media entertainment, etc, can buy free paid media content credit, using the system as proposed, and can offer this credit to the end user as promotion, when the end user buys the products or using the service or as a way to increase product awareness. Using the system which will be integrated in different platforms an end user can access the content advertisement free.

S.7 The system as proposed will enable an end user to access paid media content temporarily for free, without buying the subscription or renting or one time pay, by using the new credit as mentioned.

S.8 The system will work across different platforms, systems, computers systems, mobiles, tablets, web browsers, websites, mobiles, tablets, AR/VR sets, television sets, and other visual, audio devices, which are being used for entertainment.

S.9 This proposed platform system will give an end user credit based on what the end user is watching or is accessing the service or content, using the services or the products and services that are bought, and the same credit can be applied towards either accessing the content for free which otherwise needs to be paid.

S.10 There exists not a way which can work across different media platforms, the system as proposed can work across different media and entertainment platforms, giving the end user the ability to purchase or earn some form of credit across systems, but be able to apply it across different platforms, vendors to access the media content it desires.

S.11 The system will create a unique way in which media can be traded across different platform, regions and geographies. Powered by the token as described it will be not only possible to buy the rights to access the media from one platform or the other, but also trade, and gain appreciation gains on the media rights bought, get paid for usage. Also using some of the unique features of the system it will be possible to create new categorization and bundling of the media content to create newer subscriptions and ways the media content can be accessed.

S.12 Using the pioneer real time active content and placeholders as described in detail in the specifications, advertisements can be shown without interrupting the experience of the entertainment and result in much pleasant, positive influence.

S.13 Using the pioneer innovative technique as described in the specification new ways have been shown to promote the product much effectively other than using the advertisement. Also the system as such tries to make the advertisement massage, to have much more positive influence. The system uniquely give direct credit to the end user and money spent on the advertisement is directly transferred to the end user as this new credit, giving access to the user to what is desired making the money spent on advertisement more direct and more influential.

S.14 The system as such build using the new credit token and fully online using the latest high bandwidth technology and other innovative techniques, builds fully online media market place across different platforms, geographies, where the content can be not only traded freely, royalty be earned directly, with very high degree of collaboration and the ability to publish across different platforms without much hassle.

### BRIEF DESCRIPTION OF THE SEVERAL VIEWS OF THE DRAWING

### DW.1 Drawing 1: Logical Architectural Diagram of Free Paid Media Entertainment Credit System FPMECS

DW.1.1 Drawing 1, is the logical diagram of the “Free Paid Media Entertainment Credit System” FPMECS. Listed below are the different parts of the drawing 1, listed from numbers 1 to 25.

DW.1.2 1 Complete FPMECS, is the logical architectural diagram which list all the components in it. Further in detailed description D2 further elaborates that.

DW.1.3 2 is “UCPMMP” is the universal cross platform media market place which integrates and exposes multiple media platforms. Not only the access is seamless, but also the trading between the platforms is seamless. Further with ultra high bandwidth and super consumable architecture it makes even the non online platform online and all the exchanges are online. Also enabling realtime collaboration, trading, access and publishing.

DW.1.4 3 is CAS credit accumulator system, CAS is center piece of the system, and is the governing agent for free media credit. It uses the FPMCT token as a means of unit to accumulate credit and uses different modules for its work as further described in D.4.

DW.1.5 4 is FPMSC is free paid media credit store, that holds the FPMCT, as they are acquired by an entity, by an individual, or by a business. Further as described in D.8.

DW.1.6 5 is FPMCT is the digital token, which is the digital representation of the unit of free paid media credit, and is unique having a life of its own. The FPMSC along with CAS and FPMCSL, has governing rules for its creation, generation, transfer and conversion to other currencies. Further as described in detail in D.3.

DW.1.7 6 is FPMCSL is free paid media credit scale, that will determine the relationship between the FPMCT, number of paid content, the seconds of paid content, the dollar value of the paid content, the dollar value of FPMC, the dollar value of FPMCT unit, the impact of currency on FPMCT, the demand and the prime time impact. Further as described in detail in D.7.

DW.1.8 7 is FPMCCC is free paid media credit currency converter, that convert the token to dollar value, for a given currency and vice versa, and uses the FPMCSL for rules. Further as described in detail in D.10.

DW.1.9 8 is FMCCPG is free paid media credit currency payment gateways, and it completes monetary transections between FPMECS, banks, credit cards, businesses. Further as described in detail in D.11.

DW.1.10 9 is External Media's Bank/Payment System. It respects the system or institution the external media platform uses. It is a traditional bank, a payment gateway or a credit card system.

DW.1.11 10 is External Media Platform, is the external media platform or service with which the system interacts with using different modes, and in this particular case as elaborated using the API and streaming engine. Further as described in detail in D.14

DW.1.12 11 and 15 is DW.1.3 2 and 16: is FPMIAPISE, which is free paid media integration API and streaming engine using which the system can integrate with any system and can works across any media platform, service or streaming engine. This is API layer on top of the all the components and modules of the FPMECS, as all the components and modules are created with SOA based principle, with the API first approach. It is also responsible to communicate with all the external systems. Further embedded with the API is steaming engine with conversion and interoperability logic, which interfaces with the external systems and does the necessary lightweight conversion of streaming engine of the external platform. Further the detailed description is given in D.14.

DW.1.13 12 is FPMCSW free paid media content selector widget, which appears in external media platforms and can enable free media content on invocation. Further as described in detail in D.18. DW.1.14 13 is External Media Platform, is another variation of 10, where it is shown the integration is achieved in conjugation with FPMCSW and CASAAD. Further as described in detail in D.14 and D.19.

DW.1.15 14 is CASAAD is CAS agent and adapter, that can be embedded in any media platform, games, web browsers, websites, mobiles, tablets, AR/VR services/games, streaming services and can accumulate the credits based on the usage, or can apply the credit to gain access to the paid content or service. Further as described in detail in D.19.

DW.1.16 11 and 15 is FPMIAPISE, which is free paid media integration API and streaming engine. This is API layer on top of the all the components and modules of the FPMECS, as all the components and modules are created with SOA based principle, with the API first approach. It is also responsible to communicate with all the external systems. Further embedded with the API is steaming engine with conversion and interoperability logic, which interfaces with the external systems and does the necessary lightweight conversion of streaming engine of the external platform. Further the detailed description is given in D.14.

DW.1.17 16 is FPMCIE is heavy weight unique conversion engine, with some pioneer technologies which can make media exchange and streaming between different media platforms, technologies and consuming devices seamless. Further as described in D.9.

DW.1.18 17 is EAEP which can embedded a platform in it and can embedded multiple platforms in it, giving a homogenous feel and usability to work across different platforms. Further as described in detail in D.15.

DW.1.19 18 is External Media Platform is another variation of 10 and 13, where the integration is complemented using the EAEP.

DW.1.20 19 is PCS per content based access, which grants access to a particular media content or a slice of media service. Further as described in detail in D.21.

DW.1.21 20 is SSBS is sub subscription breakup system which divides a complete subscription from a external media provider into smaller subscriptions based on the part of access to content based on different categorization or duration of the subscription. Further as described in detail in D.22.

DW.1.22 21 is SPTA/SPA. Where SPTA subscription pass through which passes the subscription as it is from the external media platform or a part of the subscription, for free media access based on credit. SPA buys a pool of subscription from the external media provider and from this shared pool, manages individual subscriptions to give appropriate access. Further as described in detail in D.20.

DW.1.23 22 is FPMCCAE free paid media content catalog and engine, which manages all the external media platforms, advertisement platforms, marketing platforms and content, and which readily shows all the media platforms, services and media content which is available to access. FPMCCAE further uses SPTA/SPA, SSBS, PCS. Further as described in detail in D.5.

DW.1.24 23 is BWLFMC barcode and QR code with linked free media content, which generates the barcodes and QR code with linked free paid media content, which can be put on product or promotion, it comes with “active on buy” option and becomes only active when the product is bought or service is enabled. Further as described in detail in D.19.

DW.1.25 24 is APPTCA is automatic product purchase to CAS accumulation APPTCA, which automatically accumulates CAS based on the product purchase. Further as described in detail in D.16.

DW.1.26 25 is LPTCASL is loyalty program to CAS linker, that automatically extract the promotions from the products or services a user buys from loyalty program of a company and accumulate the credits to the CAS. Further as described in detail in D.13.

DW.1.27 28 is “Advertisement Platform”, is an example of external advertisement platform.

DW.1.28 29 is “Marketing Platform” and is depicting the external marketing platforms.

### DW.2 Drawing 2: FPMCT Lifecycle State Diagram

DW.2.1 Drawing 2: Depicts the complete life cycle of the FPMCT token from creation to henceforth, each state depicts its functionality and transition to one or other states.

DW.2.2 1 is “Token Recycle” is token recycle state, where the digital code, USPDDT and all the parameters are reset and new token is created altogether. This state is not normally used but only in extreme circumstances, if ever needed.

DW.2.3 2 is “Creation” state is the initialization state, where the token in created the first time. This state is the first state in the FPMCT lifecycle, in this state the new digital code is created along with USPDDT and all the parameters are set to define the new token as such. The “Creation” stage directly leads token to “Initial Pool”.

DW.2.4 3 is “Initial Pool” which represents all the digital tokens complete with all its parameters, USPDDT and ready to get initialized. This state is staging state, and the digital token goes through this stage multiple times over the course of its lifetime. This stage also acts like a reservoir of tokens ready to be used as needed. “Creation”, “Token Circulation De-Active” and “Token Recycle” state transitions a token to “Initial Pool”. From “Initial Pool” a token can transition to “Token Recycle”, “Token Circulation Active” and very extreme case by case to “Token Destroy”.

DW.2.5 4 is “Token Circulation Active” which set the token ready for circulation, and puts the token in circulation. From “Token Circulation Active”, the token can transition to either “In Circulation Non Conditional” or “In Circulation Token Buyout”.

DW.2.6 5 is “Token Destroy” is extremely rare state and under very rare scenarios a digital token is destroyed altogether and all the parameters are reset along with USPDDT. Only from “Initial Pool” a token can transition to “Token Destroy”.

DW.2.7 6 is “In Circulation Non Conditional” is state where the set to active state without any condition, nor any other parameters governing the special features of the token are set. Along with the equivalent value, units, unit to value, token relative fraction is set by going into that state, and also token appreciation/de-appreciation is set. This state is primarily used as the initial creation or subsequent liquidity demand. After this state the token is in circulation and is transitioned to “In Circulation” state.

DW.2.8 7 is “In Circulation” state which signifies that he token is in circulation and the token can go from 1 to n, transfers. From the “In Circulation” state the token goes to “Token Transfer” state.

DW.2.9 8 and 11 is “Token Transfer” state where the token from 1 to n, transfers. Some of the very unique features of the transfer, pertains to transfers with asset linkage, threshold usage on transfer, and appreciation, de-appreciation active. “Token Transfer” state can lead to “Transfer with Asset Linkage”, “Threshold, Appreciation/Depreciation active transfer” and “Token Payout”.

DW.2.10 9 is “Transfer with Asset Linkage” this is the unique state which is interim between the transfer and in this state if the transfer with asset linkage is active, with the very asset affinity, using the threshold, a part of the threshold is used to remit to the asset affinity tokens. This is an interim state with both ends leading to “Token Transfer”.

DW.2.11 10 is “Threshold, Appreciation/Depreciation active transfer” this is the unique state which is interim between the transfers and in this state the if threshold is active, a part of the threshold active is remitted to CAS for each transfer, hence each transfer with the asset and participant based on the transfer flow increases the value. If the Appreciation/Depreciation is active based on threshold and asset affinity, the fraction appreciation/depreciation values are set. This is an interim state with both ends leading to “Token Transfer”.

DW.2.12 12 is “Token Payout” is the state where the token is set to deactivated and is removed from circulation, also based on the interim states “Token Appreciation/Depreciation” and “Token Relative Fraction” an appropriate value to remitted and paid out. In this state the token transitions to “Token Relative Fraction” and “Token Appreciation/De-appreciation” and back. After this state the token is in not in circulation and is transitioned to “Token Circulation De-Active” state.

DW.2.13 13 is “Token Appreciation/Depreciation” is the state which is interim in nature, and based on the FPMCSL scale, “Threshold” value remitted and CAS accrued, circulation, demand and transfer with asset linkage, governs and appreciates or depreciates the token value is active. As this is the interim state, the originating and ending state are always the same, which can be, “Token Transfer”, “Token Payout”, “In Circulation Token Buyout”.

DW.2.14 14 is “In Circulation Token Buyout” is state the token is set to circulation with the equivalent value in deposited and the appropriate value is set. Along with the equivalent value, units, unit to value, token relative fraction is set by going into that state, and also token appreciation/de-appreciation is set. Also in this state the “Threshold” transfer factor is set, if active. In this state the token transitions to “Token Relative Fraction” and “Token Appreciation/De-appreciation” and back. After this state the token is in circulation and is transitioned to “In Circulation” state.

DW.2.15 15 is “Token Circulation De-Active” is the state in which the token is not in the circulation anymore, and is transferred to the “Initial Pool”. From this state the token transitions to the “Initial Pool” state.

DW.2.16 16 is “Token Relative Fraction” is the state which is interim in nature, and based on the FPMCSL scale, various parameters are used to the set relative value of the token, pertaining to buyout, payout or transfer. As this is the interim state, the originating and ending state are always the same, which can be, “Token Transfer”, “Token Payout”, “In Circulation Token Buyout”.

### DW.3 Drawing 3: FPMCT Digital Token Logical Diagram

DW.3.1 Drawing 3: Depicts the logical diagram of the digital token as such.

DW.3.2 1 is “Hash Code Linked Chain Transfer, State, Value” is the linked hash code chain, depicting, all the transfers values, parameters at that state, value, units, units to value, states and transitions henceforth.

DW.3.3 2 is “32 Digit Alphanumeric Code” is the unique random code which signifies the token.

DW.3.3 3 is “Unique Hidden Sequence” is the hidden unique increment sequence with the code.

DW.3.3 4 is “Threshold” is the percentage value of the total token value which increases or decreases based on each transfer when active.

DW.3.3 5 is “Relative Fraction Appreciation Depreciation” is the unique set of parameters with the corresponding logic, which is used by CAS, FPMCSL, and where the relative faction is for the state based which is determined based on the relative state and holding party. Whereas appreciation depreciation is set of parameters which signify and govern the tokens appreciation depreciation characteristics.

DW.3.3 6 is “USPDDT” is the ultra secure, temper proof secure technique which makes any transfer creation and circulation ultra secure.

### DW.4 Drawing 4: Logical Architectural Diagram of UCPMMP

DW.4.1 Drawing 4: Depicts the Logical Diagram of the UCPMMP.

DW.4.2 1 is “Universal Media Market Place” is the universal market place which integrates and exposes multiple media platforms. Not only the access is seamless, but also the trading between the platforms is seamless. Further with very high bandwidth and super consumable architecture it makes even the non online platform online and all the exchanges are online. Thus the market place makes online collaboration across platforms, regions, and enables to trade and publish content across platforms and regions in realtime. Further as described in D.23.

DW.4.3 2 is “FPMCCAE” is free paid media content catalog and engine, which manages all the external media platforms and content, and which readily shows all the media platforms, services and media content which is available to access, trade or publish. FPMCCAE further uses SPTA/SPA, SSBS, PCS, AFS. Further as described in detail in D.5.

DW.4.4 3 is “FPMCIE” is heavy weight unique conversion engine, with pioneer technologies which can make media exchange and streaming between different media platforms, technologies and consuming devices seamless. Further as described in D.9.

DW.4.5 4 is “FPMIAPISE” is which is free paid media integration API and light weight streaming engine. This is API layer on top of the all the components and modules of the FPMECS and external systems, as all the components and modules are created with SOA based principle, with the API first approach. Further embedded with the API is steaming engine with conversion and interoperability logic, which interfaces with the external systems and does the lightweight conversion of streaming engine of the external platform. Further the detailed description is given in D.14.

DW.4.6 5 and 6 is “External Media Platform” is the external media platform or service with which the system interacts with using different modes, and in this particular case as elaborated using the API and streaming engine. Further as described in detail in D.14.

DW.4.7 7 and 8 is “External Media Platform/CASAAD” External Media Platform, is another variation of 10, where it is shown the integration is achieved in conjugation with FPMCSW and CASAAD. Further as described in detail in D.14 and D.19.

DW.4.8 9 and 10 is “External Media Platform/EAEP” is another variation of 10 and 13, where the integration is complemented using the EAEP. Further EAEP which can embedded a platform in it and can embedded multiple platforms in it, giving a homogenous feel and usability to work across different platforms. Further as described in detail in D.15.

DW.4.9 11 is “Advertisement Platform” is external advertisement platform with which the system interacts. The system uses the advertisement platforms and data for creating custom rules, which govern the FPMCT unit value, trading and publishing.

DW.4.8 12 is “Marketing Platform” is the external marketing platform which the system interacts. The system pulls in marketing data to get/publish insights, create custom rules, and apply cross region customizations, exposing optimal marketing strategies.

### DW.6 Drawing 5: Pioneer Ultra Secure and High Speed Communication Conduit

DW.6.1 Drawing 5: Pioneer ultra secure and high speed communication conduit.

DW.6.2 1 “FPMECS”, advertisement free media entertainment credit system, communication with other systems.

DW.6.3 2 UCPMMP, is universal cross platform media market place communication with other systems.

DW.6.4 3 is USAHSPIC, is Ultra Secure and High Speed Conduit, is pioneer and innovative technology, with ability to use multiple channels. This pioneer technology is the backbone of the of ultra high speed and secure transfer of data, making collaboration, trading, publishing and functionality of the system realtime. Various systems as shown connect to the this conduit, and especially with the streaming, media codec interplay, format conversion, it is possible for various other wise non compatible systems to work seamlessly.

DW.6.5 4 “High Speed Fiber” depicting the ultra high bandwidth and high speed fiber channel.

DW.6.6 5 and 10 “External Media platform” is an example of external media platform.

DW.6.7 6 “Advertisement Platform”, is an example of external advertisement platform.

DW.6.8 7 “Wireless” is the depicting the wireless communication channel.

DW.6.9 8 “Marketing Platform” is depicting the external marketing platforms.

DW.6.10 9 “Satellite” is depicting the satellite communication channel.

### DW.7 Drawing 6: Logical Diagram of FPMCSW with Example

DW.7.1 Drawing 6: Logical diagram of “Free Paid Media Content Selector Widget” AFMCSW with an example showing two states from website page and AFMCSW widget on a web browser. State 1 is when website webpage has paid content with limited access and state 2 is when AFMCSW is activated and on the same webpage the paid content is displayed. The FPMCSW uses various techniques behind the scene to get access to the paid content.

DW.7.2 1 Is state 1. showing the hosting software, as in this case is a web browser on which FPMCSW is added as widget or extension. FPMCSW can be placed in any media content provider or hosting software as in this case it is a web browser.

DW.7.3 2 is an example of restriction due to pad content on the website page.

DW.7.4 4 is an example of a website page which has paid content.

DW.7.5 5 is an example of the content that is being displayed partially and not showing the paid content.

DW.7.6 5 and 6 is the state of 2 of the above.

DW.7.7 7 is state 2 showing the same content with full access.

### DW.8 Drawing 7: Logical Diagram of BWLFMC with Example

DW.8.1 Drawing 7: Logical diagram of “Barcode and QR code with Linked Free Paid Media Content” BWLFMC with an example showing two different examples. Example 1 shows the streaming media content a movie in this case, in a web browser. Example 2, show a movie in case of TV. In both the example the still is when a user tires to access the content and the access is not granted but a massage is displayed. As this content has BWLFMC, what is shown is an instruction that advises the user with the corresponding QR code which the end user can scan and can access the paid content.

DW.8.2 1 Is an example (1) showing a particular website with steaming content in it.

DW.8.3 2 is an example of instruction advising the user that, to get access to the paid content there is an option of BWLFMC.

DW.8.4 3 is an example of the QR code that can be scanned to get the access to the paid content after applying the free paid media credit.

DW.8.5 4 is an the content that is paused and is not visible and in this case it is a movie.

DW.8.5 5 is the massage advising the user that the content is paid and to gain access either need to be pay or buy subscription.

DW.8.7 6 is the example (2) of the hosting platform that is showing the content in this case it is a TV. DW.8.8 7 is an example of instruction advising the user that, to get access to the paid content there is an option of BWLFMC.

DW.8.9 8 is an example of the QR code that can be scanned to get the access to the paid content after applying the free paid media credit.

DW.8.10 9 is an the content that is paused and is not visible and in this case it is a movie.

DW.8.11 10 is the massage advising the user that the content is paid and to gain access either need to be pay or buy subscription.

### DW.9 Drawing 8: Logical Diagram of BWLFMC on Product with Example

DW.9.1 Drawing 8: Logical diagram of “Barcode and QR code with Linked Free Paid Media Content” BWLFMC with an example as it appears on a product.

DW.9.2 1 Is an example of product case.

DW.9.3 1 Is an example showing the BWLFMC QR on the product case.

DW.9.4 1 Is an example showing promotion instructing the user to scan the QR code to watch a free movie.

### DESCRIPTION

### Detailed Description of the Invention

Intend to invent and create, free paid media entertainment media credit system and media market place, which will enable an end user to access media entertainment, games, websites, mobiles, tablets, AR/VR, streaming services, on any platform, temporarily for free using the new credit system which otherwise needs to be paid and trade, publish media. The system builds free paid media credit based on a users different usage of products, services, promotions on other products and services that give free media credit. Buying products that will give this credit and will apply on the platform of users liking to show the paid content without paying rather than using the credit. This system will embed many media systems underneath making it a universal cross media platform market place powered by digital token, also giving the end user seamless access to the media of liking by using the new credit system, collaborating, trading media or publishing across systems in realtime.

P.1 Intend to invent and create, free paid media entertainment credit system, which will enable an end user to access media entertainment, games, websites, mobiles apps, tablets apps, AR/VR, streaming services, on any platform, temporarily for free using the credit which otherwise needs to be paid. The system will comprise of various computer system, engines and api's that will intact with existing or new media entertainment platforms, marketing and advertisement systems.

P.2 Intend to invent and create cross platform system, which will help end users earn credit, based on the users use of different services, media entertainment services, purchase of products and services, where this credit can be applied on media platforms like YouTube, apple iTunes, games, websites, mobiles apps, tablets apps, AR/VR, streaming services, on any platform etc, to access content temporarily for free which otherwise needs to be paid or access content without advertisement.

P.3 The system accumulate the credit for an end user from different platforms, services the end user use, promotions that give the end user the credit, and for the users liking the system will grant access to paid content by passing the credit to platform where the end user wants to access the paid content. P.4 The system gives temporary access to the end user to the premiere services using the earned credit which otherwise needs to be paid.

P.5 Different manufacturers, stores, shops, media entertainment, etc, can buy advertisement free and free paid media content credit, using the system as proposed, and can offer this credit to the end user as promotion, or when the end user buys the products. Using the system which is integrated in different platforms an end user can access the content.

P.6 The system as proposed will enable an end user to access media content for free temporarily which other wise, need to be paid, and without buying the subscription or renting or one time pay, and by just using the new credit as mentioned.

P.7 The system will work across different platforms, systems, computers systems, mobiles, tablets, web browsers, websites, mobiles, tablets, AR/VR sets, television sets, and other visual, audio devices, which are being used for entertainment.

P.8 This proposed platform system will give an end user credit based on what the end user is accessing or watching or playing, using the services or the products and services that are bought, and the same credit can be applied towards accessing the content for free which otherwise needs to be paid.

P.9 The system will also work real time, just as an example within an content or game need to be paid for next level or extra content, there will exist an option where an user can redeem the free credit to access the content or level which otherwise need to be paid.

P.10 The system is built of various computer systems, having logic and programming, to infer logic of different modules as mentioned below, and to integrate with other platforms. The system uses service oriented architecture SOA and API, with API first approach to expose these modules using FPMIAPISE.

P.11 “DW.1 Drawing 1” explains the logical diagram of the complete system as built. Slight here is presented the overall overview of the system and is further each sub system and module is described in the individual sub sections, from D1 to D22.

P.12 CAS credit accumulator system, CAS is center piece of the system, and is the governing agent for free media credit. It uses the FPMST token as a means of unit to accumulate credit and uses different modules for its work as further described in D.4. CAS is also responsible for the life cycle of FPMCT and its transfer to and from different systems. FPMCT is the digital token, which is the digital representation of the unit of free media credit, and is unique having a life of its own. The FPMSC has governing rules for its creation, generation, transfer and conversion to other currencies, its relative buying power of paid media content and the appreciation or decoration pertaining to a particular media platform or content therefore. Further as described in detail in D.3 CAS uses the FPMSC is free paid media credit store, that holds the FPMCT as they are acquired by an entity, by an individual, or by a business or the initial set pool for the system to start working as described further in D.8.

P.13 CAS and the credit store uses FPMCSL which is free paid media credit scale, that determine the relationship between the FPMCT, number of paid content, the seconds of paid content, the dollar value of the paid content, the dollar value of FPMCT, the impact of currency on FPMCT, the demand and the prime time impact. Further its relative buying power of paid media content and the appreciation or depreciation pertaining to a particular media platform or content therefore. Further as described in detail in D.7.

P.14 FPMIAPISE is free paid media integration API and streaming engine. This is API layer on top of the all the components and modules of the FPMECS, as all the components and modules are created with SOA based principle, with the API first approach. Further embedded with the API is steaming engine with conversion and interoperability logic, which interfaces with the external systems and does the necessary conversion of streaming engine of the external platform. Further the detailed description is given in D.14.

P.15 CAS uses FMCCPG which is free paid media credit currency payment gateways, and it completes monetary transections between FPMECS, banks, credit cards, businesses by using FPMIAPISE, further is uses FPMCCC which is free paid media credit currency converter, that convert the token to dollar value, for a given currency and vice versa, and uses the FPMCSL for rules. The transactions can also be complete using only the FPMCT also, without using any conversion to a currency or henceforth, in that case the conversion is from token to token. Further as described in detail in D.11.

P.16 The other critical sub system is FPMCCAE which is free paid media content catalog and engine, which manages all the external media platforms, types of media platforms, type of content, different content, type of access to access the content, categorization of content, subscriptions, durations, per user access, streaming services, games, games services, Web browsers, websites, mobiles, tablets, AR/VR games and services and henceforth. It also has visual GUIs which readily shows all the media platforms, services and media content which is available to access. FPMCCAE also manages the content, its value in terms of credit token, duration, unit of access per token and both FPMCCAE and CAS work in tandem to get the content and give access to the end users. FPMCCAE further uses SPTA/SPA, SSBS, PCS, for different categorization of content access from the external media platforms. Where most common external content managing and access techniques implemented are SPTA/SPA, SSBS, PCS. SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the new credit system the user might be entitled to only 10 days of the subscription of a service which is billed month to month normally. In this case the system will give access to the user for 10 days out of the month's subscription and will use the remaining days of the subscription to another eligible user. Further as described in detail in D.20. The PCS per content based access, which grants access to a particular media content or a slice of media service and is most commonly used. Further as described in detail in D.21. Further SSBS is sub subscription breakup system which divides a complete subscription from a external media provider into smaller subscriptions based on the part of access to content based on different categorization or duration of the subscription. To give an example say a “L” subscription has access to “p” number games of television, SSBS can generate custom rules to divide into “n” number of smaller subscriptions have access to “y” number of games. Further as described in detail in D.22.

P.17 The system as such as described in Drawing 1, uses two other modes by which free paid media credit is invoked in the external system. FPMCSW free paid media content selector widget, which appears in external media platforms and can enable free media content on invocation. Further as described in detail in D.18. Where as CASAAD is CAS agent and adapter, that can be embedded in any media platform, games, web browsers, websites, mobiles, tablets, AR/VR services/games, streaming services and can accumulate the credits based on the usage, or can apply the credit to gain access to the paid content or service. Further as described in detail in D.19.

P.18 Lastly the system as such has the ability to embed the extern media system in it, using the EAEP which can embedded a platform in it. It can further embedded multiple platforms in it, giving a homogenous feel and usability to work across different platforms. Further as described in detail in D.15.

P.19 FPMECS also has the ability to free media credit benefits on buying of the products. And especially is beneficial to a company or a retail store or a business or entity, which wants gain customer loyalty through “Direct Impact Promotions™” by giving free paid media credit as promotion. Consider a scenario, e.g. say a drinks company wants to give a promotion, where if an end user buys “n” number of cases, they get to see a paid movie for free, using the free paid media credit, which the company as such buys from FPMECS. This functionality is achieved through BWLFMC, which barcode and QR code with linked free media content, which generates the barcodes and QR code with linked free paid media content, which can be put on product or promotion, it comes with “active on buy” option and becomes only active when the product is bought or service is enabled. Further as described in detail in D.19. Further on same lines APPTCA is automatic product purchase to CAS accumulation APPTCA, which automatically accumulates CAS based on the product purchase. Further as described in detail in D.16.

P.19 FPMECS striking feature is that it gives advertisement free credit benefits on buying of the products. And especially is beneficial to a company which wants gain customer loyalty through “Direct Impact Promotions™” by giving advertisement free paid media credit as promotion. Consider a scenario, e.g. say a drinks company wants to give a promotion, where if an end user buys “n” number of cases, they get to see a famous movie for advertisement free, using the free paid media credit, which the company as such buys the credit from FPMECS and gives to customer. This functionality is achieved through BWLFMC, which barcode and QR code with linked advertisement free media content, this system generates the barcodes and QR code with linked advertisement free media content, which can be put on product or promotion, it comes with “active on buy” option and becomes only active when the product is bought or service is enabled. Further as described in detail in D.19. Further on same lines APPTCA is automatic product purchase to CAS accumulation APPTCA, which automatically accumulates CAS based on the product purchase. Further as described in detail in D.16.

P.20 Also the system also work across loyalty programs of a product, manufacturer or retailer store using the LPTCASL, which is loyalty program to CAS linker, that automatically extract the promotions from the products or services a user buys from loyalty program of a company and accumulate the credits to the CAS.

P.21 The system as such will also enable other unique features, one being “interplatform content trading”, the system as such will make it one universal platform for content purchase and repurchase, allowing vendors to make custom subscriptions and henceforth. The other feature being “Content resalable monetary retained value” e.g. say at a particular time, if a content is published and x number of tokens were used to buy as a unit for y number of access rights, and as the demand for content increases, the bought access rights can be resold at a higher price. Interoperability with any media or content provider. The system will be work with any media or content provider. Further described in D.23.

P.22 Using the universal cross-platform media market place UCPMMP, the system will create a unique way in which media can be traded across different platform, regions and geographies. Powered by the token as described it will be not only possible to buy the rights to access the media from one platform or the other, but also trade, and again appreciation gains on the media rights bought. Also using some of the unique features of the system it will be possible to create new categorization and bundling of the media content to create newer subscriptions and ways the media content can be accessed. Further described in D.23.

P.23 As the goal of the system is to achieve highest Interoperability, the libraries of the system is implemented in multiple programming languages. The first implementation being in python, then java, c # with native functionality in C, C++, VC++. The interfaces written in cross platform frameworks, with mobile responsive and AR/VR convertible. Web scripting is used with HTML, javascript, ajax just to name a fe, json. The system as built adheres to principles of software as a services, having containerization. The system is also resized as mobile application, tablet application, AR/VR application, web application, desktop application and server application. Further agents of app media streaming protocols implemented which and encapsulated behind the API, and streaming engine. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is the pioneer system which uses extremely high bandwidth, high speed multichannel, with ultra high speed fiber, and satellite channels, with the pioneer ultra conduit technology. Also as is implemented as SAAS in multi region, communication between its different multi region SAAS, across different geographies and countries, enabling to access media and transfer media in almost realtime and is pioneer fully online.

### P.24 GLOSSARY

*FPMECS: Free paid media entertainment credit system.
*FPMCT: Free paid media credit token.
*CAS: Credit accumulator system.
*FPMCSL: Free paid media credit scale.
*FPMCS: Free paid media credit store.
*FPMCIE: Free paid media credit integration engine.
*FPMCCC: Free paid media credit currency converter.
*FMCCPG: Free paid media credit currency payment gateways.
*RTCAE: real time credit application engine.
*LPTCASL: loyalty program to CAS linker.
*CASAAD: CAS agent and adapter.
*FPMIAPISE: Free paid media integration API and streaming engine.
*EAEP: Encapsulating and embedding platform.
*APPTCA: Automatic product purchase to CAS accumulation.
*FPMCC: Free paid media content catalog.
*FPMCSW: Free paid media content selector widget.
*BWLFMC: Barcode with linked free media content.
*UCPMMP: Universal cross-platform media market place.

P.25 *Media: Here media is broadly used to entertainment systems/platforms like, streaming services like YouTube, apple iTunes, twitch, Netflix, Azure Cloud, Google Cloud, Web browsers, websites, mobiles, tablets, AR/VR systems, Television Channels to name a few.

P.26 *Entertainment Media: Here entertainment media is broadly used to entertainment systems like, streaming services like YouTube, apple iTunes, twitch, Netflix, Azure Cloud, Google Cloud, Web browsers, websites, mobiles, tablets, AR/VR systems, Television Channels to name a few.

P.27 *“External Media System” or “External Media Platform”: are used to represent the software or technology implementation of the “Media” or “Entrainment Media” as described above.

P.28 Content: Content is broadly used to represent any form of digital content, which can be a song, songs, movie, movies, television, TV apps, game, games, web browsers, websites, mobiles apps/games, tablets apps/games, AR/VR apps, AR/VR games, serial, serials, documentary, documentaries, hosting service, cloud compute, cloud storage, any public cloud resource.

P.29 *“Manufacturer” or “Company” or “Retail Store” or “Online Store” Or “External Media System” or “External Media Platform” or “Public Cloud Provider” or “Advertisement Company” or “Marketing Company”: are interchangeably used to represent an entity using the system for desired result as described.

### D.1 Cross Platform Interoperability

D.1.1 Cross platform inter operability, FPMECS, is achieved by many unique ways, by its ability to connect with different media systems, advertisement systems, marketing systems, in many different ways. Basically FPMECS will be able to connect in many different ways with media systems as described. FPMECS connect's using, the highly versatile api, the adapter, the integration engine, the embedded mode, the light weight streaming engine, the heavy weight streaming engine or the conduit. This unique feature will allow the FPMECS to have wider inter operability.

D.1.2 In the first mode of interoperability is achieved through “free paid media integration API and streaming engine FPMIAPISE”. FPMIAPISE which is based on SOA architecture and high customizable API exposes widest range of end points for any platform to connect. Further the RESTful API with expandability support of OData, GraphQL, and other technologies, and by having simultaneous implementations, makes the API high customizable and highly interoperable. All the modules communicate with each other also using the API based approach, further making system highly interoperatable. Further the platform is highly interoperatable as each sub system has private, public, on demand protected interface, making the sub systems also available to connect to external systems sub systems on needed basis. Lastly FPMIAPISE has a streaming engine behind the media access API's with the ability to convert streaming or encapsulate streaming.

D.1.3 In the second mode of “free paid media content selector widget FPMCSW”, the widget itself is embed in the external media platform. The widget encapsulates all the functionality, and innovation logic in it. With very simple way to integrate into the platform, by simply coping few lines of code for an api invocation, can enable the full feature of FPMCS in a media platform.

D.1.4 The third mode is “CAS agent and adapter” CASAAD, in this the implementation of the required functionality by importing the libraries, in the code of the external media platform. With the functionality embedded in the code itself, FPMCS can work more seamlessly in the external media platform.

D.1.5 The system as such will also enable other unique features, one being “interplatform content trading”, the system as such will make one universal platform for content purchase and repurchase, also allowing vendors to make custom subscriptions and henceforth. That will be possible with the all the content being under on digital FPMECS, connected with each other using ultra high bandwidth and speed fiber cable connections. Secondly on single digital token will make the trade, simple and free, with the system able to create the right bundles on content and transfer the ownership of the media as such, across different platforms, geographies and countries. The other feature being “Content resalable monetary retained value” e.g. say at a particular time, if a content is published and x number of tokens with units, were used to buy as a unit for y number of access rights, and as the demand for content increases, the bought access rights can be resold at a higher price with unique feature as described in the sections below. Lastly with the unique threshold value proposition, the media content creator will get paid subsequently over any media content right transfer or access, giving the content creators the right value for their effort. The system work with any media or content provider with above mentioned technology as such.

D.1.6 Further with SSBS which is sub subscription breakup system which divides a complete subscription from a external media provider into smaller subscriptions based on the part of access to content based on different categorization or duration of the subscription, it will be possible to create highly customized content with mix and match across different platforms, systems, and geographies.

### D.2 Detailed Description with Architectural Diagrams and Drawings, Working FPMECS

D.2.1 “DW.1 Drawing 1 is the logical architectural diagram and drawing of the system as built. Further D.3 to D.25 goes into detail about explaining the individual components of the system as built, and also explains how the whole system works with external systems. The system is built of various computer systems, having logic and programming, to infer logic of different modules as mentioned below, and to integrate with other platforms. The system uses service oriented architecture and API, with API first approach to expose these modules using FPMIAPISE D.2.2 “DW.1 Drawing 1” explains the logical diagram of the complete system as built. Slightly here is presented the overall overview of the system and is further each sub system and module is described in the individual sub sections, from D1 to D25.

D.2.3 CAS credit accumulator system, CAS is center piece of the system, and is the governing agent for free media credit. It uses the FPMCT token as a means of unit to accumulate credit and uses different modules for its work as further described in D.4. CAS is also responsible for the life cycle of FPMCT and its transfer to and from different systems. FPMCT is the digital token, which is the digital representation of the unit of free media credit, and is unique having a life of its own. The FPMSC has governing rules for its creation, generation, transfer and conversion to other currencies, its relative buying power of paid media content and the appreciation or decoration pertaining to a particular media platform or content therefore. Further as described in detail in D.3 CAS uses the FPMSC is free paid media credit store, that holds the FPMC, as they are acquired by an entity, by an individual, or by a business or the initial set pool for the system to start working as described further in D.8.

D.2.4 CAS and the credit store uses FPMCSL which is free paid media credit scale, that will determine the relationship between the FPMC, number of paid content, the seconds of paid content, the dollar value of the paid content, the dollar value of FPMC, the impact of currency on FPMC, the demand and the prime time impact. Further its relative buying power of paid media content and the appreciation or depreciation pertaining to a particular media platform or content therefore. Further as described in detail in D.7.

D.2.5 FPMIAPISE is free paid media integration API and streaming engine. This is API layer on top of the all the components and modules of the FPMECS, as all the components and modules are created with SOA based principle, with the API first approach. Further embedded with the API is steaming engine with conversion and interoperability logic, which interfaces with the external systems and does the necessary conversion of streaming engine of the external platform. Further the detailed description is given in D.14.

D.2.6 CAS uses FMCCPG which is free paid media credit currency payment gateways, and it completes monetary transections between FPMECS, banks, credit cards, businesses by using FPMIAPISE, further is uses FPMCCC which is free paid media credit currency converter, that convert the token to dollar value, for a given currency and vice versa, and uses the FPMCSL for rules. The transactions can also be complete using only the FPMC also, without using any conversion to a currency or henceforth. Further as described in detail in D.11.

D.2.7 The other critical sub system is FPMCCAE which is free paid media content catalog and engine, which manages all the external media platforms, types of media platforms, type of content, different content, type of access to access the content, categorization of content, subscriptions, durations, per user access, streaming services, games, games services, Web browsers, websites, mobiles, tablets, AR/VR games and services and henceforth. It also has visual GUIs which readily shows all the media platforms, services and media content which is available to access. FPMCCAE also manages the content, its value in terms of credit token, duration, unit of access per token and both FPMCCAE and CAS work in tandem to get the content and give access to the end users. FPMCCAE further uses SPTA/SPA, SSBS, PCS, for different categorization of content access from the external media platforms. Where most common external content managing and access techniques implemented are SPTA/SPA, SSBS, PCS. SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the new credit system the user might be entitled to only 10 days of the subscription of a service which is billed month to month normally. In this case the system will give access to the user for 10 days out of the month's subscription and will use the remaining days of the subscription to another eligible user. Further as described in detail in D.20. The PCS per content based access, which grants access to a particular media content or a slice of media service and is most commonly used. Further as described in detail in D.21. Further SSBS is sub subscription breakup system which divides a complete subscription from a external media provider into smaller subscriptions based on the part of access to content based on different categorization or duration of the subscription. To give an example say a “L” subscription has access to “p” number games of television, SSBS can generate custom rules to divide into “n” number of smaller subscriptions have access to “y” number of games. Further as described in detail in D.21.

D.2.8 The system as such as described in Drawing 1, uses two other modes by which free paid media credit is invoked in the external system. FPMCSW free paid media content selector widget, which appears in external media platforms and can enable free paid media content on invocation. Further as described in detail in D.18. Where as CASAAD is CAS agent and adapter, that can be embedded in any media platform, games, web browsers, websites, mobiles, tablets, AR/VR services/games, streaming services, web browsers, mobiles, tables and can accumulate the credits based on the usage, or can apply the credit to gain access to the content or service or remove advertisements all together. Further as described in detail in D.19.

D.2.9 Lastly the system as such has the ability to embed the extern media system in it, using the EAEP which can embedded a platform in it. It can further embedded multiple platforms in it, giving a homogenous feel and usability to work across different platforms. Further as described in detail in D.15.

D.2.10 FPMECS striking feature is that it gives free paid media credit benefits on buying of the products. And especially is beneficial to a company or a retail store or a business or entity, which wants gain customer loyalty through “Direct Impact Promotions™” by giving free paid media credit as promotion. Consider a scenario, e.g. say a drinks company wants to give a promotion, where if an end user buys “n” number of cases, they get to see a paid movie for free, using the free paid media credit, which the company as such buys from FPMECS. This functionality is achieved through BWLFMC, which barcode and QR code with linked free media content, which generates the barcodes and QR code with linked free paid media content, which can be put on product or promotion, it comes with “active on buy” option and becomes only active when the product is bought or service is enabled. Further as described in detail in D.19. Further on same lines APPTCA is automatic product purchase to CAS accumulation APPTCA, which automatically accumulates CAS based on the product purchase. Further as described in detail in D.16.

D.2.11 Also the system also work across loyalty programs of a product, manufacturer or retailer store using the LPTCASL, which is loyalty program to CAS linker, that automatically extract the promotions from the products or services a user buys from loyalty program of a company and accumulate the credits to the CAS.

D.2.12 The system as such will also enable other unique features, one being “interplatform content trading”, the system as such will make it one universal platform for content purchase and repurchase, allowing vendors to make custom subscriptions and henceforth. The other feature being “Content resalable monetary retained value” e.g. say at a particular time, if a content is published and x number of tokens were used to buy as a unit for y number of access rights, and as the demand for content increases, the bought access rights can be resold at a higher price with unique feature as described in the section D.3 and D.23.

D.2.13 Using the universal cross-platform media market place UCPMMP, the system will create a unique way in which media can be traded across different platform, regions and geographies. Powered by the token as described it will be not only possible to buy the rights to access the media from one platform or the other, but also trade, and again appreciation gains on the media rights bought. Also using some of the unique features of the system it will be possible to create new categorization and bundling of the media content to create newer subscriptions and ways the media content can be accessed. Further described in D.23.

D.2.14 The following applies to the whole system, each sub system and module. As the goal of the system is to achieve highest Interoperability, the libraries of the system is implemented in multiple programming languages. The first implementation being in python, then java, c # with native functionality in C, C++, VC++. The interfaces written in cross platform frameworks, with mobile responsive and AR/VR convertible. Web scripting is used with HTML, javascript, ajax just to name a fe, json. The system as built adheres to principles of software as a services, having containerization. The system is also resized as mobile application, tablet application, AR/VR application, web application, desktop application and server application. Further agents of app media streaming protocols implemented which and encapsulated behind the API, and streaming engine. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is the pioneer system which uses extremely high bandwidth, high speed multichannel, with ultra high speed fiber, and satellite channels, with the pioneer ultra conduit technology. Also as is implemented as SAAS in multi region, communication between its different multi region SAAS, across different geographies and countries, enabling to access media and transfer media in almost realtime and is pioneer fully online.

### D.3 Detailed Description with Architectural Diagrams and Drawings, Working of FPMCT Token

D.3.1 FPMCT is the digital token, which is the digital representation of the unit of free media credit, and is unique having a life of its own. The FPMSC has governing rules for its creation, generation, transfer and conversion to other currencies D.3.2 FPMCT uses highly secure methods for its creation and one of the most striking is secretive USPDDT method for temper proof creation and transfer. With this method it will be impossible to create, replicate or transfer the token. Further its relative buying power of paid media content and the appreciation or decoration pertaining to a particular media platform or content therefore. CAS uses the FPMSC is free paid media credit store, that holds the FPMC, as they are acquired by an entity, by an individual, or by a business or the initial set pool for the system to start working as described further.

### D.3.3 Digital Token

D.3.3.1 A Digital token is best described as 5 part digital representation as described below.
16 Digit Alpha Numeric Code.
A simple sequence attached to the Alpha Numeric Code.
Hash cain code with state, transfer, threshold value, units, unit to value, appreciation and life cycle.
USPDDT ultra secure, temper proff secure technique.
Digital token to asset value linkage and transfer to accumulation active with threshold.

D.3.3.2 This is a very unique way of digital representation of the token, where some of the unique characteristics of the token will give unique access, and media rights. Further the value of the token is decoupled from the token itself, with the unit of the token. A single token with start with 1 token to 1 unit, but can then increase or decrease in number of units. So there can be different tokens with different number of units in them. Also a unit can be fractional in nature unto 5 places of decimal. And the value of the token is realized by the different parameters threshold, relative royalty and rarity of the token as such. The most interesting and unique being with asset linkage, will give owner ship rights along with the access and decoupled. Also based on the transition and flow, with hash life linkage, the token gives unique propositions when appreciation, de appreciation is active.

D.3.3.3 Drawing 3: Depicts the logical diagram of the digital token as such.

D.3.3.4 1 is “Hash Code Linked Chain Transfer, State, Value” is the linked hash code chain, depicting value, units, units to value, all the transfers values, all the transfers, parameters at that state, states and transitions henceforth.

D.3.3.5 2 is “32 Digit Alphanumeric Code” is the unique random code which signifies the token.

D.3.3.6 3 is “Unique Hidden Sequence” is the hidden unique increment sequence with the code.

D.3.3.7 4 is “Threshold” is the percentage value of the total token value which increases or decreases based on each transfer when active.

D.3.3.8 5 is “Relative Fraction Appreciation Depreciation” is the unique set of parameters with the corresponding logic, which is used by CAS, FPMCSL, and where the relative faction is for the state based which is determined based on the relative state and holding party. Whereas appreciation depreciation is set of parameters which signify and govern the tokens appreciation depreciation characteristics.

D.3.3.9 6 is “USPDDT” is the ultra secure, temper proof secure technique which makes any transfer creation and circulation ultra secure.

### D.3.4 Initial Issuing

For the initial working of the system an “x” amount of the tokens will be issued.

### D.3.5 Types of Token

Tokens will come with some overrides giving different flavors to the token as such. Some of the override are.
Currency Lock—Token can be bought and sold only in the currency it was bough it.
Asset linkage token—Token can appreciate or depreciate in value based on the linked platform or media asset.
Transfer to credit accumulator active or not—this unique feature will credit token to the asset on each positive transfer leading to the increase in the value of the media asset over time.
Threshold, Appreciation/Depreciation active transfer
   Transfer to transfer
   Transfer to asset
   Transfer to creation
Token Appreciation/Depreciation
Token Relative Fraction

### D.3.6 States of the Token

D.3.6.1 Drawing 2: Depicts the complete life cycle of the FPMSC token from creation to henceforth, each state depicts its functionality and transition to one or other states.

D.3.6.2 1 is “Token Recycle” is token recycle state, where the digital code, USPDDT and all the parameters are reset and new token is created altogether. This state is not normally used but only in extreme circumstances, if ever needed.

D.3.6.3 2 is “Creation” state is the initialization state, where the token in created the first time. This state is the first state in the FPMSC lifecycle, in this state the new digital code is created along with USPDDT and all the parameters are set to define the new token as such. The “Creation” stage directly leads token to “Initial Pool”.

D.3.6.4 3 is “Initial Pool” which represents all the digital tokens complete with all its parameters, USPDDT and ready to get initialized. This state is staging state, and the digital token goes through this stage multiple times over the course of its lifetime. This stage also acts like a reservoir of tokens ready to be used as needed. “Creation”, “Token Circulation De-Active” and “Token Recycle” state transitions a token to “Initial Pool”. From “Initial Pool” a token can transition to “Token Recycle”, “Token Circulation Active” and very extreme case by case to “Token Destroy”.

D.3.6.5 4 is “Token Circulation Active” which set the token ready for circulation, and puts the token in circulation. From “Token Circulation Active”, the token can transition to either “In Circulation Non Conditional” or “In Circulation Token Buyout”.

D.3.6.6 5 is “Token Destroy” is extremely rare state and under very rare scenarios a digital token is destroyed altogether and all the parameters are reset along with USPDDT. Only from “Initial Pool” a token can transition to “Token Destroy”.

D.3.6.7 6 is “In Circulation Non Conditional” is state where the set to active state without any condition, nor any other parameters governing the special features of the token are set. This state is primarily used as the initial creation or subsequent liquidity demand. After this state the token is in circulation and is transitioned to “In Circulation” state.

D.3.6.8 7 is “In Circulation” state which signifies that he token is in circulation and the token can go from 1 to n, transfers. From the “In Circulation” state the token goes to “Token Transfer” state.

D.3.6.9 8 and 11 is “Token Transfer” state where the token from 1 to n, transfers. Some of the very unique features of the transfer, pertains to transfers with asset linkage, threshold usage on transfer, and appreciation, de-appreciation active. “Token Transfer” state can lead to “Transfer with Asset Linkage”, “Threshold, Appreciation/Depreciation active transfer” and “Token Payout”.

D.3.6.10 9 is “Transfer with Asset Linkage” this is the unique state which is interim between the transfer and in this state if the transfer with asset linkage is active, with the very asset affinity, using the threshold, a part of the threshold is used to remit to the asset affinity tokens. This is an interim state with both ends leading to “Token Transfer.”

D.3.6.11 10 is “Threshold, Appreciation/Depreciation active transfer” this is the unique state which is interim between the transfers and in this state the if threshold is active, a part of the threshold active is remitted to CAS for each transfer, hence each transfer with the asset and participant based on the transfer flow increases the value. If the Appreciation/Depreciation is active based on threshold and asset affinity, the fraction appreciation/depreciation values are set. This is an interim state with both ends leading to “Token Transfer”.

D.3.6.12 12 is “Token Payout” is the state where the token is set to deactivated and is removed from circulation, also based on the interim states “Token Appreciation/Depreciation” and “Token Relative Fraction” an appropriate value to remitted and paid out. In this state the token transitions to “Token Relative Fraction” and “Token Appreciation/De-appreciation” and back. After this state the token is in not in circulation and is transitioned to “Token Circulation De-Active” state.

D.3.6.13 13 is “Token Appreciation/Depreciation” is the state which is interim in nature, and based on the FPMCSL scale, “Threshold” value remitted and CAS accrued, circulation, demand and transfer with asset linkage, governs and appreciates or depreciates the token value is active. As this is the interim state, the originating and ending state are always the same, which can be, “Token Transfer”, “Token Payout”, “In Circulation Token Buyout”.

D.3.6.14 14 is “In Circulation Token Buyout” is state the token is set to circulation with the equivalent value in deposited and the appropriate value is set. Along with the equivalent value, token relative fraction is set by going into that state, and also token appreciation/de-appreciation is set. Also in this state the “Threshold” transfer factor is set, if active. In this state the token transitions to “Token Relative Fraction” and “Token Appreciation/De-appreciation” and back. After this state the token is in circulation and is transitioned to “In Circulation” state.

D.3.6.15 15 is “Token Circulation De-Active” is the state in which the token is not in the circulation anymore, and is transferred to the “Initial Pool”. From this state the token transitions to the “Initial Pool” state.

D.3.6.16 16 is “Token Relative Fraction” is the state which is interim in nature, and based on the FPMCSL scale, various parameters are used to the set relative value of the token, pertaining to buyout, payout or transfer. As this is the interim state, the originating and ending state are always the same, which can be, “Token Transfer”, “Token Payout”, “In Circulation Token Buyout”.

### D.3.7 FPMCT Relative Value Factor of Media Platform

When converting from FPMCT to a token of a media platform if the conversion is not dollar to token, a fraction will be applied. Each media platform or service will have non-constant relative fraction which with appreciating and depreciating fractions over time.

### D.3.8 Transfer to and From Dollar, Currency

Currency Lock tokens can be transferred to and from dollar and currency they were bough in.

### D.3.9 Value Retained in Media Content

A special type of token which can have asset to the asset linkage which has digital to asset value linkage and transfer to accumulation active with threshold, will have a thrash hold as defined by the credit scale. And of any asset on with transfer to credit accumulator active with this unique feature will credit token to the asset on each positive transfer leading to the increase in the value of the media asset over time.

Please Note: Token, Digital Token, Digital Credit Token, Free Paid Media Credit Token, are used interchangeably.

### D.4 Detailed Description with Architectural Diagrams and Drawings, Working of CAS

D.4.1 CAS credit accumulator system, CAS is center piece of the system, and is the governing agent for free media credit. It uses the FPMCT token as a means of unit to accumulate credit and uses different modules for its work. CAS along with FPMSC is also responsible for the life cycle of FPMCT and its transfer to and from different systems, and uses different sub systems at it disposal.

D.4.2 CAS business model how CAS is accumulated:
Manufactures, service providers, buys FPMC based media content and hand over to end users, as promotion or by buying of services or products which carry free media credit.
By the very usage of services, or access, free media credit is earned.
Loyalty points earned are converted to free paid media credit.
Traditional credit cards points earned by an end user are converted to free paid media.
As free paid media is spent in leads to accumulation of free paid media itself.
End users can buy free paid media credit which gives access to free paid media or significantly free part of the paid media.
As the system is universal cross-platform media market place, as by very nature the content published, can be accessed with lower value as it holds prerelease value, which an end user can buy.

D.4.3 To illustrate, a simple example is presented with the flow as described below:
A product manufacturer or an online store or a retail store, starts a promotion to give access to free media content, eg, access to free movie. For the purchase of 1 or multiple products.
The product manufacturer selects a list of platforms, and particular content using FPMCS
Buys the CAS credit using the FPMCS for “n” number of content
Promotion barcode and QR code is generated by the product manufacturer by using FPMCS with “active sale purchase”, where the access to the content is only available after the sale.
At the check out the barcode and QR code becomes active
User scans the barcode, QR code and is given access to the content using FPMCS.
The user either logs in FPMCS or access the content for free, a movie in this case. ???

### D.4.4 CAS Accumulator

CAS has multiple ways to accumulated credit based on the usage of the participating service, media platform or system as such or based on unique “transfer to accumulation active with threshold”. The most common form of accumulation of CAS for end user usage is going to be asset usage using the token as such. Further is described in D.3, D.5, D.6, D.7, D.14, D.15, D.16, D.19, D.18, D.19, D.23.

### D.4.5 CAS Interface

CAS has multiple interfaces pertaining to different persosnaoas that will interface with the system as such. The interfaces will show the usage, accumulation, values, transfers, balances, history, appreciation, depreciation, FPMCCAE linkage, rule engine customization, relationship lifecycle and more functionality for the working of CAS.

Some of the personas:
End User—consumer
Product Manufacturer
Service Provider
Media Platform Provider
Advertisement Provider
Media Trading users
Media Publishing Users
Universal Media Market Place users
Traditional Credit systems
Banking Systems
Auditors
Development and Support

### D.4.6 CAS to FPMCCAE Linker

CAS to FPMCCAE linker binds the two system using the API.

### D.4.7 CAS to FPMCCAE Rule Generation Engine

CAS to FPMCCAE is the rule engine that ties together the credit and the content. The rule engine will have most predefined rules, custom rules and automatic rules. For best exposing the content, with the associated token values. Further the rules will define the transections, credit value accumulation, thread value usage on each transfer and the content. Further the categorization, bundling and cross platform purchase and selling is defined by the rules. Detained below are some of the pre-defined rules, where the custom and automatic ones will be defined as the system is used over time.

### D.4.8 CAS to FPMCCAE Rule Generation Engine for Very Specific Content PCS

CAS and FPMCCAE, will expose a custom and an automatic rule engine that will help create rules for the best managing of the PCA. CAS will expose the interface with right token values and associated appreciation and depreciation.

### D.4.9 CAS to FPMCCAE Rule Generation Engine for Free Paid Media Credit

CAS and FPMCCAE, will expose a custom and an automatic rule engine that will help create rules for the best managing generating the free paid media credit based on both the usage of the system by the end user and also by the threshold token usage on each transfer. Once the credit is accumulate the CAS uses the token store to save the value as earned.

### D.4.10 CAS to FPMCCAE Rule Generation Engine for Subscription SPTA/SPA and PCA

CAS and FPMCCAE, will expose a custom and an automatic rule engine that will help create rules for the best managing of the SPTA/SPA. CAS will expose the interface with right token values and associated appreciation and depreciation.

### D.4.11 CAS to FPMCCAE Rule Generation Engine for SSBS

CAS and FPMCCAE, will expose a custom and an automatic rule engine that will help create SSBS, based on user usage and for best managing of the SPTA/SPA and PCA. CAS will expose the interface with right token values and associated appreciation and depreciation.

### D.4.12 In Store Purchase to CAS Accumulation

In this case a manufacturer might enroll in free media credit for each product that is bought, hence in this case as products are bought credit is automatically accumulated as described in D.16.

### D.4.13 Product Purchase to CAS Accumulation

In this case a manufacturer might enroll in free media credit for each product that is bought online or otherwise, hence in this case as products are bought credit is automatically accumulated as described in D.16.

### D.4.14 Product Promotion to CAS

In this case a manufacturer might enroll in free media credit for a certain promotion on the product, that is bought online or otherwise, hence in this case as products are bought, the user will get access to either a fixed free media credit or as dictated by the promotion, very specific content attached to the promotion. Further as explained in D.19.

### D.4.15 Product Promotion to CAS Action to Certain Content Access

In this case service provider or media provider might enroll is CAS to content access, in this case as the end user accesses certain content the user accumulates free media credit. Further as explained in D.19.

### D.4.16 Custom and Automatic Rules

More custom and automatic rules are created based on different scenarios mentioned in this doc an upon user usage.

### D.5 Detailed Description with Architectural Diagrams and Drawings, Working of External Media Content Catalogue FPMCCAE

D.5.1 FPMCCAE is media content catalog and engine, which manages all the external media platforms and content, and which readily shows all the media platforms, services and media content which is available to access. It manages all the external media platforms, types of media platforms, type of content, different content, type of access to access the content, categorization of content, subscriptions, durations, per user access, streaming services, games, games services, web browsers, websites, mobiles, tablets, AR/VR games and services and henceforth. Further it categorically shows the free paid media for access. Further FPMCCAE further uses SPTA/SPA, SSBS, PCS to apply free paid media credit, by working in tandem with CAS, participating systems, media platforms, advertisement platforms, marketing platforms etc.. Lastly based on the above mentioned, the FPMCCAE manages the buying rights for the contents and the services henceforth.

D.5.2 The type of media content and media platforms are:
Games
Media Channel
Music Platform e.g. YouTube, iTunes
Video Platform
Games Platform
Live music platforms
Music Radio station
Streaming Service
Music Streaming Service e.g. Twitch
Video streaming service
Web browsers, websites, mobiles, tablets, AR/VR platform
AR/VR streaming service
AR/VR games
Websites
Paid Websites
Cloud Services
Digital Content
Pictures
Paid Websites
News
Social Media like Facebook, Instragram
Social Media News

D.5.3 Type content that credit can be applied to: the Types wiz:
Minutes of subscription
Hours of Subscription
Days of Subscription
Months of Subscription
Minutes of usage of service
Hours of usage of service
Days of usage of service
Months of usage of service
Access to the a particular media content
Access to bucket of media content
Access to full content under the subscription
Access to a part under the full content under the subscription
Access to the custom part of content under the full subscription
Creating own bucket or subscription

D.5.4 It also has visual GUIs which readily shows all the media platforms, services and media content which is available to access. FPMCCAE also manages the content, its value in terms of credit token, duration, unit of access per token and both FPMCCAE and CAS work in tandem to get the content and give access to the end users. FPMCCAE further uses SPTA/SPA, SSBS, PCS, for different categorization of content access from the external media platforms. Where most common external content managing and access techniques implemented are SPTA/SPA, SSBS, PCS. SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the new credit system the user might be entitled to only 10 days of the subscription of a service which is billed month to month normally. In this case the system will give access to the user for 10 days out of the month's subscription and will use the remaining days of the subscription to another eligible user. Further as described in detail in D.20. The PCS per content based access, which grants access to a particular media content or a slice of media service and is most commonly used. Further as described in detail in D.21. Further SSBS is sub subscription breakup system which divides a complete subscription from a external media provider into smaller subscriptions based on the part of access to content based on different categorization or duration of the subscription. To give an example say “a” subscription has access to “p” number games of television, SSBS can generate custom rules to divide into “n” number of smaller subscriptions have access to “y” number of games. SSBS also exposes the functionality to the end user where they can mix and match content across different platforms and engine to create sub subscriptions or bucket of content to show as subscription. Further as described in detail in D.22.

D.5.5 Having a universal token and cross platform operability, gives the platform unique ability to trade and exchange media*, media content, subscriptions, across platform and geographies. Further with the unique SSBS feature gives the ability to mix and match content, lastly with unique features of the token, makes free trade possible across systems and with threshold feature, gives tremendous payouts to the content creators. Further as described in D.3, D.22, D.23.

### D.6 Detailed Description with Architectural Diagrams and Drawings, Working of External Media paid to free credit applying widget EMPTFCAW

D.6.1 External Media paid to free credit applying widget, is a functionality unit or widget that will appear on the external media content platform, using which a user can readily apply the free paid media credit

D.6.3 Further it acts as CAS agent and adapter, when embedded in media platform, games, Web browsers, websites, mobiles, tablets, AR/VR services/games, streaming services and can accumulate the credits based on the usage, or can apply the credit to gain access to the paid content or service.

### D.7 Detailed Description with Architectural diagrams and Drawings, Working FPMCSL

D.7.1 CAS and the credit store uses FPMCSL which is media credit scale, that will determine the relationship between the FPMC, number of paid content, the seconds of paid content, the dollar value of the paid content, the dollar value of FPMC, the impact of currency on FPMC, the demand and the prime time impact. Further its relative buying power of paid media content and the appreciation or depreciation pertaining to a particular media platform or content therefore. FPMCSL is the delicate link between the CAS, FPMCT, the media platforms, the advertisement platforms, marketing platforms, manufacturers, retail stores, etc, digesting in financial, advertisement, marketing, media data, and showing in to create the right rule for advertisement free content slices and at the same time create automatic rules from the data as such. Hence, FPMCSL has the has set of predefined rules, custom rules and automatic rules based on usage, which are invoked by the different states of the FPMC, as invoked by CAS. The most important states where FPMCSL has most rules are “Token relative fraction”, “Token Appreciation/Depreciation”, “Transfer With Asset linkage”, “Threshold, Appreciation/depreciation active”, “In Circulation Token Buyout” and “Token Payout”.

D.7.2 CAS uses PFMCCPG which is free paid media credit currency payment gateways, and it completes monetary transections between FPMECS, banks, credit cards, advertisements platforms, marketing platforms, businesses by using FPMIAPISE, further is uses FPMCCC which is free paid media credit currency converter, that convert the token to dollar value, for a given currency and vice versa, and uses the FPMCSL for rules.

### D.8 Detailed Description with Architectural Diagrams and Drawings, Working FPMCS

D.8.1 FPMSC is free paid media credit store, that holds the FPMCT, as they are acquired by an entity, by an individual, or by a business or media platform or advertisement platform or marketing platform Almost all the states of the FPMCT are realized through the FPMSC in conjunction with CAS. FPMSC also holds all the financial and transactional information for an entity, which can be a media platform, a manufacturer, an end user, a system user or financial institution or media platform or advertisement platform or marketing platform as such. FPMSC works in tandem with the CAS for the state management for FPMCT, as invoked by the FPMCCAE.

D.8.2 The FPMSC has governing rules for its creation, generation, transfer and conversion to other currencies, its relative buying power of advertisement free media content and the appreciation or depreciation pertaining to a particular media platform or content therefore.

### D.9 Detailed Description with Architectural Diagrams and Drawings, Working FPMCIE

D.9.1 FPMCIE is heavy weight unique conversion engine, with some pioneer technologies which can make media exchange and streaming between different media platforms, technologies and consuming devices seamless. Though FPMIAPISE has some capabilities of conversion between different media platforms and their technologies, but is very lightweight and can be used in only scenarios where there is not a big miss match between to and fro technologies. Where as FPMCIE is specifically made to only take care of conversions and achieve 100% interoperatability and make intera-platform content trading seamless.

D.9.2 Mentioned Below Are Some of the Conversions:
Static content to streaming.
Conversion through intermediary storage.
Analog to digital.
Digital to digital with bandwidth optimization for low or high bandwidth.
Steaming technology 1 to streaming technology 2.
Fixed streaming to AR/VR and viceversa.
Access with encapsulation with continuous conversion.

D.9.3 As shown in Diagram 1, and 2. A typical communication starts with FPMIAPISE, using HTTP/TCP protocols. FPMIAPISE does set up the framework where the light weight engine is invoked if needed which passes on the stream or content as needed, and can do some conversion.

D.9.4 Further if the two parties, that is either the media platforms and media platform or media platform or FPMECS, are not compatible, in that case FPMIAPISE sets up the framework and passes control which uses only TCP, UPP, but other media specific and latest protocols, to apply all the different methodologies mentioned above.

### D.10 Detailed Description With Architectural Diagrams and Drawings, Working FPMCCC

D.10.1 FPMCCC is media credit currency converter, that convert the token to dollar value, for a given currency and vice versa, and uses the FPMCSL for rules. Typically as replicated by the state of FPMCT, “Token Payout” or “Token Buyout” in case monetary online cash is involved. The FPMCT has a value part after the state which is communicated to the FPMECS and the transaction with financial institution as by the FPMCS for that entity.

### D.11 Detailed Description With Architectural Diagrams and Drawings, Working FMCCPG

D.11.1 FMCCPG is media credit currency payment gateways, and it completes monetary transections between FPMECS, banks, credit cards, businesses. Typically as replicated by the state of FPMC, “Token Payout” or “Token Buyout” in case monetary online cash is involved, which invokes the FMCCPG permeating to value transection for the entity as invoked by the CAS via FPMCS. The FPMC has a value part after the state which is communicated to the FPMECS and the transaction with financial institution as by the FPMCS for that entity.

### D.12 Detailed Description With Architectural Diagrams and Drawings, Working RTCAE

D.12.1 Real time credit application engine, RTCAE, using which credit can be applied in real time to the content that is being shown to access the paid content or to be accessed content for free using the credit rather than paying., further RTCAE has linkage to QR code, where if an advertisement is being shown and if the QR code is rest of the content access or feature access is granted using the credit without paying by applying the credit.

D.12.2 A typical flow is, a product manufacturer or product or an advertisement or marketing company will buy credit, and the system will generate the appropriate QR code which can be embedded in the content. The content as such shows this QR code along side the other content, with the new kind of direct benefit credit and such when the manufacturer's advertisements are being displayed, if the user has the credit, can scan the QR code. Once scanned successfully the system will detect the valid scan, and actively using the RTCAE, change the content mode to not display the advertisement using different techniques mentioned in D.21, D.22, D.23.

### D.13 Detailed Description With Architectural Diagrams and Drawings, Working of LPTCASL

D.13.1 LPTCASL is loyalty program to CAS linker, that automatically extract the promotions from the products or services a user buys from loyalty program of a company and accumulate the credits to the CAS. The linkage is possible using the FPMIAPISE, and using API to LPTCASL linkage of participating manufacturer, store, selling platform's loyalty program and FPMECS.

### D.14 Detailed Description With Architectural Diagrams and Drawings, Working of FPMIAPISE

D.14.1 FPMIAPISE is free paid media integration API and streaming engine. This is API layer on top of the all the components and modules of the FPMECS, as all the components and modules are created with SOA based principle, with the API first approach, and is also the layer that talks with external platforms. Further embedded with the API is steaming engine with conversion and interoperability logic, which interfaces with the external systems and does the necessary conversion of streaming engine of the external platform. The system as built adheres to principles of software as a services, having containerization. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable.

D.14.2 FPMIAPISE which is based on SOA architecture and high customizable API exposes widest range of end points for any platform to connect. Further the RESTful API with expandability support of OData, GraphQL, new unique customizable endpoints technology and by having simultaneous implementations, makes the API high customizable and highly interoperable. All the modules communicate with each other, also use the API based approach, further making system highly interoperatable. Further the platform is highly interoperatable as each sub system has private, public, on demand protected interface, making the sub systems also available to connect to external systems sub systems on needed basis. Lastly FPMIAPISE has a lightweight streaming engine behind the media access API's with the ability to convert streaming or encapsulate streaming.

### D.15 Detailed Description With Architectural Diagrams and Drawings, Working of EAEP

D.15.1 is EAEP which can embed a platform in it and can embedded multiple platforms in it, giving a homogenous feel and usability to work across different platforms. It does so my encapsulating the platform in it or it can extract content from the host system, regroup them and reshow it sub shared interface, doing so for multiple platforms give it a feeling as there are multiple platforms embedded in it.

### D.16 Detailed Description With Architectural Diagrams and Drawings, Working of APPTCA

D.16.1 is APPTCA is automatic product purchase or service usage to CAS accumulation APPTCA, which automatically accumulates CAS based on the product purchase. The functionality is achieved with BWLFMC with option APPTCA active which can automatically start accumulating the credit for the users that buy the products in store or online.

### D.17 Detailed Description With Architectural Diagrams and Drawings, Working of BWLFMC

D.19.1 BWLFMC barcode and QR code with linked free paid media content, which generates the barcodes and QR code with linked free paid media content, which can be put on product or promotion, it comes with “active on buy” option and becomes only active when the product is bought or service is enabled.

D.19.2 A company or a retail store or a business or entity, which wants gain customer loyalty through “Direct Impact Promotions™” by giving free paid media credit as promotion, can use BWLFMC. The functionality is described using the scenario e.g. say a drinks company wants to give a promotion, where if an end user buys “n” number of cases, they get to see a famous movie for free, using the free paid media credit, which the company as such buys the credit from FPMECS and gives to customer. This functionality is achieved through BWLFMC, which barcode and QR code with linked free paid media content, this system generates the barcodes and QR code with linked free paid media content, which can be put on product or promotion, it comes with “active on buy” option and becomes only active when the product is bought or service is enabled. When the end user scans the QR code the system shows the appropriate instructions to the end user to access the media content free. Behind the scene the system interacts with the participating, promotion providing entity, advertisement platform, media platform and does the appropriate FPMCT transections.

DW.19.3 Drawing 7: Logical diagram of “Barcode and QR code with Linked Free Paid Media Content” BWLFMC with an example showing two different examples. Example 1 shows the streaming media content a movie in this case, in a web browser. Example 2, show a movie in case of TV. In both the example the still is when a user tires to access the content and the access is not granted but a massage is displayed. As this content has BWLFMC, what is shown is an instruction that advises the user with the corresponding QR code which the end user can scan and can access the paid content.

DW.19.4 1 Is an example (1) showing a particular website with steaming content in it.

DW.19.5 2 is an example of instruction advising the user that, to get access to the paid content there is an option of BWLFMC.

DW.19.6 3 is an example of the QR code that can be scanned to get the access to the paid content after applying the free paid media credit.

DW.19.7 4 is an the content that is paused and is not visible and in this case it is a movie.

DW.19.8 5 is the massage advising the user that the content is paid and to gain access either need to be pay or buy subscription.

DW.19.9 6 is the example (2) of the hosting platform that is showing the content in this case it is a TV.

DW.19.10 7 is an example of instruction advising the user that, to get access to the paid content there is an option of BWLFMC.

DW.19.11 8 is an example of the QR code that can be scanned to get the access to the paid content after applying the free paid media credit.

DW.19.12 9 is an the content that is paused and is not visible and in this case it is a movie.

DW.19.13 10 is the massage advising the user that the content is paid and to gain access either need to be pay or buy subscription.

DW.19.14 Drawing 8: Logical diagram of “Barcode and QR code with Linked Free Paid Media Content” BWLFMC with an example as it appears on a product.

DW.19.15 1 Is an example of product case.

DW.19.16 1 Is an example showing the BWLFMC QR on the product case.

DW.19.17 1 Is an example showing promotion instructing the user to scan the QR code to watch a free movie.

### D.18 Detailed Description With Architectural Diagrams and Drawings, Working of FPMCSW

D.18.1 FPMCSW free paid media content selector widget, which appears in external media platforms which can be any media platform, games, web browsers, websites, mobiles, tablets, AR/VR services/games, streaming services, web browsers, mobiles, tables and can enable free paid media content on invocation.

D.18.2 The widget itself is embedded in the external media platform. The widget encapsulates all the functionality, and innovation logic in it. With very simple way to integrate into the platform, that is by simply coping few lines of code for an api invocation, can enable the full feature of FPMECS in a media platform.

D.18.3 Further the widget is embedded in web browsers as an extension. And on innovation, contacts the website that is being displayed, passes on the free paid media tokens to access the paid content from the website. The widget has the option of always on, which actively looks at the website that is opened and tries access the paid content by giving the credit to the website that is being displayed, after confirmation from the end user. Further the widget can be used to activate only a feature, or buy on the shown media content. On same lines the be any media platform, games, web browsers, websites, mobiles apps/games, TV channels, TV content, tablets apps/games, AR/VR services/games, streaming services, web browsers, mobiles, tables. It also has an “always active” option which actively keeps removing the advertisements if possible based on what the end user is accessing.

D.18.4 It also acts as a CAS accumulator, when embedded in media platform, games, web browsers, websites, mobiles, tablets, AR/VR services/games, streaming services and can accumulate the credits based on the usage, or can apply the credit to gain access to the paid content or service.

D.18.5 Drawing 6: Logical diagram of “ Free Paid Media Content Selector Widget” AFMCSW with an example showing two states from website page and AFMCSW widget on a web browser. State 1 is when website webpage has paid content with limited access and state 2 is when AFMCSW is activated and on the same webpage the paid content is displayed. The FPMCSW uses various techniques behind the scene to get access to the paid content.

D.18.6 1 Is state 1. showing the hosting software, as in this case is a web browser on which FPMCSW is added as widget or extension. FPMCSW can be placed in any media content provider or hosting software as in this case it is a web browser.

D.18.7 2 is an example of restriction due to pad content on the website page.

D.18.8 4 is an example of a website page which has paid content.

D.18.9 5 is an example of the content that is being displayed partially and not showing the paid content.

D.18.10 5 and 6 is the state of 2 of the above.

D.18.11 7 is state 2 showing the same content with full access.

### D.19 Detailed Description With Architectural Diagrams and Drawings, Working of CASAAD

D.19.1 CASAAD is CAS agent and adapter, that can be embedded in any media platform, games, web browsers, websites, mobiles, tablets, AR/VR services/games, streaming services, web browsers, mobiles, tables and can accumulate the credits based on the usage, or can apply the credit to gain access to the content or service or remove advertisements all together.

D.19.2 The implementation of the required functionality is achieved by importing the libraries, in the code of the external media platform. With the functionality embedded in the code itself, FPMECS can work more seamlessly in the external media platform. This agent can simply appear as a button with appropriate text on it, on the media platform or host software also, where the media content is being accessed.

### D.20 Detailed Description With Architectural Diagrams and Drawings, Working of SPTA/SPA

D.20.1 SPTA subscription pass through which passes the subscription as it is from the external media platform or a part of the subscription, for free media access based on credit. SPA buys a pool of subscription from the external media provider and from this shared pool, manages individual subscriptions to give appropriate access. To make is clear, please refer the following example. For example, using the new credit system the user might be entitled to only 10 days of the subscription of a service which is billed month to month normally. In this case the system will give access to the user for 10 days out of the month's subscription and will use the remaining days of the subscription to another eligible user.

### D.21 Detailed Description With Architectural Diagrams and Drawings, Working of SSBS

D.21.1 SSBS is sub subscription breakup system which divides a complete subscription from a external media provider into smaller subscriptions based on the part of access to content based on different categorization or duration of the subscription. To give an example say “L” subscription has access to “p” number games of television, SSBS can generate custom rules to divide into “n” number of smaller subscriptions have access to “y” number of games. SSBS also exposes the functionality to the end user where they can mix and match content across different platforms and engine to create sub subscriptions or bucket of content to show as subscription. Further with SSBS which is sub subscription breakup system which divides a complete subscription from a external media provider into smaller subscriptions based on the part of access to content based on different categorization or duration of the subscription, it will be possible to create highly customized content with mix and match across different platforms, systems, and geographies.

D.21.2 CPS, cross platform subscription is a pioneer subscription, which can span across multiple cross platform media platform, devices and geographies.

### D.22 Detailed Description With Architectural Diagrams and Drawings, Working of PCS

D.22.1 PCS per content based access, which grants access to a particular media content or a slice of media service. The PCS per content based access, which grants access to a particular media content or a slice of media service and is most commonly used.

### D.23 Detailed Description With Architectural Diagrams and Drawings, Working of UCPMMP

D.23.1 “Universal Media Market Place” is the universal market place which integrates and exposes multiple media platforms. This is the pioneer fully online media marketplace. Not only the access is seamless, but also the trading between the platforms is seamless. Further with very high bandwidth and super consumable architecture it makes even the non online platform online and all the exchanges are online. Also enabling realtime collaboration, trading, access and publishing. The system as such will also enable other unique features, one being “interplatform content trading”, the system as such will make it one universal platform for content purchase and repurchase, allowing vendors to make custom subscriptions and henceforth. The other feature being “Content resalable monetary retained value” e.g. say at a particular time, if a content is published and x number of tokens were used to buy as a unit for y number of access rights, and as the demand for content increases, the bought access rights can be resold at a higher price with unique feature. With above mentioned features the market place makes online collaboration across platforms, regions, and enables to trade and publish content across platforms and regions in realtime.

D.23.2 This pioneer features are possible with the all the content being under on digital PFMCT, connected with each other using ultra high bandwidth and speed fiber cable connections. Secondly on single digital token will make the trade, simple and free, with the system able to create the right bundles on content and transfer the ownership of the media as such, across different platforms, geographies and countries. The other feature being “Content resalable monetary retained value” e.g. say at a particular time, if a content is published and x number of tokens were used to buy as a unit for y number of access rights, and as the demand for content increases, the bought access rights can be resold at a higher price with unique feature as described in the section. Lastly with the unique threshold value proposition, the media content creator will get paid subsequently over any media content right transfer or access, giving the content creators the right value for their effort.

D.23.3 Further with SSBS which is sub subscription breakup system which divides a complete subscription from a external media provider into smaller subscriptions based on the part of access to content based on different categorization or duration of the subscription, it will be possible to create highly customized content with mix and match across different platforms, systems, and geographies. Also CPS, cross platform subscription is a pioneer subscription, which can span across multiple cross platform media platform, devices and geographies.

D.23.4 Further with the unique feature of UCPMMP it will be possible to publish content in the media market place, monetize it and push it all the media platforms with a single simple interface. D.1 also explains how the platform interopeataibility and the features described in this doc will enable this feature.

D.23.5 The trading agent of the UCPMMP is responsible for making trades across multiple media platform devices, channels and geographies.

D.23.6 The publishing agent of the UCPMMP is responsible for publishing content across multiple media platform devices, channels and geographies.

D.23.7 Drawing 4: Depicts the logical diagram of the UCPMMP.

D.23.8 1 is “Universal Media Market Place” is the universal market place which integrates and exposes multiple media platforms. Not only the access is seamless, but also the trading between the platforms is seamless. Further with very high bandwidth and super consumable architecture it makes even the non online platform online and all the exchanges are online. Also enabling realtime collaboration, trading, access and publishing.

D.23.9 2 is “FPMCCAE” is free paid media content catalog and engine, which manages all the external media platforms and content, and which readily shows all the media platforms, services and media content which is available to access. FPMCCAE further uses SPTA/SPA, SSBS, PCS Further as described in detail in D.5.

D.23.10 3 is “FPMCIE” is heavy weight unique conversion engine, with some pioneer technologies which can make media exchange and streaming between different media platforms, technologies and consuming devices seamless. Further as described in D.9.

D.23.11 4 is “FPMIAPISE” is which is free paid media integration API and light weight streaming engine. This is API layer on top of the all the components and modules of the FPMECS, as all the components and modules are created with SOA based principle, with the API first approach. Further embedded with the API is steaming engine with conversion and interoperability logic, which interfaces with the external systems and does the necessary conversion of streaming engine of the external platform. Further the detailed description is given in D.14.

D.23.12 5 and 6 is “External Media Platform” is the external media platform or service with which the system interacts with using different modes, and in this particular case as elaborated using the API and streaming engine. Further as described in detail in D.14.

D.23.13 7 and 8 is “External Media Platform/CASAAD” External Media Platform, is another variation of 10, where it is shown the integration is achieved in conjugation with FPMCSW and CASAAD. Further as described in detail in D.14 and D.19.

D.23.14 9 and 10 is “External Media Platform/EAEP” is another variation of 10 and 13, where the integration is complemented using the EAEP. Further EAEP which can embedded a platform in it and can embedded multiple platforms in it, giving a homogenous feel and usability to work across different platforms. Further as described in detail in D.15.

D.4.15 11 is “Advertisement Platform” is external advertisement platform with which the system interacts. The system uses the advertisement platforms and data for creating custom rules, which govern the FPMCT unit value, trading and publishing.

D.4.16 12 is “Marketing Platform” is the external marketing platform which the system interacts. The system pulls in marketing data to get/publish insights, create custom rules, and apply cross region customizations, exposing optimal marketing strategies.

### D.20 Detailed Description With Architectural Diagrams and Drawings, Working of Different Sub Systems, Systems and Interactions Between Them

D.25 As the goal of the system is to achieve highest Interoperability, the libraries of the system is implemented in multiple programming languages. The first implementation being in python, then java, c # with native functionality in C, C++, VC++. The interfaces written in cross platform frameworks, with mobile responsive and AR/VR convertible. Web scripting is used with HTML, javascript, ajax just to name a few, json. The system as built adheres to principles of software as a services, having containerization. The system is also resized as mobile application, tablet application, AR/VR application, web application, desktop application and server application. Further agents of app media streaming protocols implemented which and encapsulated behind the API, and streaming engine. Giving the system to simultaneously hosted on prem, data centers, and its own public cloud. All the functionality for all the modules is developed with SOA (service oriented architecture) with the API first approach with public, protected and private interfaces, these interfaces further makes the system very highly interoperable. The system uses other existing frameworks for mobile, tablet and AR/VR. The system also uses mysql, Postgres, file system along with very secure hash safe custom native persistent data structures, and data lake. The system as such is the pioneer system which uses extremely high bandwidth, high speed multichannel, with ultra high speed fiber, and satellite channels, with the pioneer ultra conduit technology. Also as is implemented as SAAS in multi region, communication between its different multi region SAAS, across different geographies and countries, enabling to access media and transfer media in almost realtime and is pioneer fully online.

D.25.2 Further Drawing 5: Pioneer ultra secure and high speed communication conduit D.25.3 1 “FPMECS”, advertisement free media entertainment credit system, communication with other systems.

D.25.4 2 UCPMMP, is universal cross platform media market place communication with other systems.

D.25.5 3 is USAHSPIC, is Ultra Secure and High Speed Protocol Conduit, is pioneer and innovative technology. This pioneer technology is the backbone of the of ultra high speed and secure transfer of data, making collaboration, trading, publishing and functionality of the system realtime. Various systems as shown connect to the this conduit, and especially with the streaming, media codec interplay, format conversion, it is possible for various other wise non compatible systems to work seamlessly.

D.25.6 4 “High Speed Fiber” depicting the ultra high bandwidth and high speed fiber channel.

D.25.7 5 and 10 “External Media platform” is an example of external media platform.

D.25.8 6 “Advertisement Platform”, is an example of external advertisement platform.

D.25.9 7 “Wireless” is the depicting the wireless channel.

D.25.10 8 “Marketing Platform” is depicting the external marketing platforms.

D.25.11 9 “Satellite” is depicting the satellite channel.

1. Claim to invent and create, Free, paid media entertainment credit system and media market place, to access paid media entertainment, paid games, paid AR/VR services/games, paid streaming services, temporarily for free across different platforms using the new credit and trade media, which enables an end user to access paid media entertainment content, games, AR/VR services/games, streaming services for free temporarily, on platforms where paid content is shown and also trade, publish.

2. Claim to invent and create, free paid media credit token, FPMCT, that defines the FPMC token.

3. Claim to invent and create, credit accumulator system, CAS, which have the logic and rules on how the credit will be accumulated, based on the promotions on the products a user buys, coupons a user have, products that give credit, media content that might give credit, usage of products or services which give credit or payment to buy credit.

4. Claim to invent and create, free paid media credit scale FPMCSL, for paid free content, FPMECS, that will determine the relationship between the FPMC, number of paid content, the seconds of paid content, the dollar value of the paid content, the dollar value of FPMC, the currency of impact on FPMC and the prime time impact.

5. Claim to invent and create, free paid media credit store, FPMCS, that holds the FPMC, as they are acquired by an entity, by an individual, by a business.

6. Claim to invent and create, free paid media credit integration engine, FPMCIE, that integrates the FPMCIE with media platforms, marketing systems, advertisement systems, currency systems and banking systems.

7. Claim to invent and create, free paid media credit currency converter, FPMCCC, that convert the token to dollar value, for a given currency and vice versa.

8. Claim to invent and create, free paid media credit currency payment gateways, FMCCPG, that completes monetary transections between FPMECS, banks, credit cards, businesses.

9. Claim to invent and create, real time credit application engine, RTCAE, using which credit can be applied in real time to the content that is being shown to gain access for free using the new credit which otherwise is paid content.

10. Claim to invent and create, CAS agent and adapter CASAAD, that can be embedded in any media platform, games, AR/VR services/games, streaming services and can accumulate the credits based on the usage, or can apply the credit to gain access to the paid content or service.

11. Claim to invent and create, loyalty program to CAS linker, LPTCASL, that will automatically extract the promotions from the products or services a user buys from loyalty program of a company and accumulate the credits to the CAS.

12. Claim to invent and create, free paid media integration API and streaming engine FPMIAPISE, using which the system can integrate with any system and can works across any media platform, service or streaming engine.

13. Claim to invent and create, encapsulating and embedding platform EAEP, which can embedded a platform in it and can embedded multiple platforms in it, giving a homogenous feel and usability to work across different platforms.

14. Claim to invent and create, automatic product purchase to CAS accumulation APPTCA, which automatically accumulates CAS based on the product purchase.

15. Claim to invent and create, free paid media content catalog and engine FPMCCAE, manages all the external media platforms and content, and which readily shows all the media platforms, services and media content which is available to explore.

16. Claim to invent and create, free paid media content selector widget FPMCSW, which appears in external media platforms and can enable free media content on invocation.

17. Claim to invent and create, barcode and QR code with linked free media content BWLFMC, which generates the barcodes with linked free paid media content.

18. Claim to invent and create, free media access based on credit and per content access PCA, which grants access to the part of the content and subscription pass through SPTA, which passes the subscription as it is from the external media platform or a part of the subscription.

19. Claim to invent and create, subscription pool SPA, with sub subscription breakup system SSBS, which shares a pool of subscription from the external media provider and further SSBS divides a complete subscription from a external media provider into smaller subscriptions based on the part of access to content based on different categorization or duration of the subscription.

20. Claim to invent and create, universal cross-platform media market place UCPMMP, which will allow free trade of media content across different platforms, regions and systems and will be powered by FPMCT.
